(19) United States
(12) Patent Application Publication
(10) Pub. No.: US 2015/0088746 A1
(43) Pub. Date: Mar. 26, 2015

(54) METHOD AND SYSTEM FOR IMPLEMENTING FINANCIAL TRANSACTIONS

(71) Applicant: SayPay Technologies, Inc., Pleasanton, CA (US)

(72) Inventor: Steven Richard Hoffman, Pleasanton, CA (US)

(73) Assignee: SayPay Technologies, Inc., Pleasanton, CA (US)

(21) Appl. No.: 14/498,643

(22) Filed: Sep. 26, 2014

Related U.S. Application Data
(60) Provisional application No. 61/882,988, filed on Sep. 26, 2013.

(51) Int. Cl. G06Q 20/40; G06Q 20/32

(52) U.S. Cl. CPC G06Q 20/40145; G06Q 20/3227
USPC 705/44

(57) ABSTRACT

A method for implementing a financial transaction via a user device is disclosed. The method involves receiving financial transaction information used to generate an alphanumeric Secure Transaction Code that binds the received information to the financial transaction, receiving information from a user device that includes the Secure Transaction Code and a voice entry of the Secure Transaction Code, verifying that the voice entry of the Secure Transaction Code corresponds to a Voice Authentication Master (VAM) file of a registered user, verifying that the received Secure Transaction Code is a valid Secure Transaction Code and, if both are verified authorizing the financial transaction and sending an indication that the financial transaction has been authorized to the user device. In an embodiment the transaction is between a merchant and user of a mobile user device or can be a request for secure access.

### CROSS-REFERENCE TO RELATED APPLICATION

This application claims priority to U.S. Provisional Application Ser. No. 61/882,988, filed Sep. 26, 2013, entitled “Transaction processing method that binds transaction identification, User authorization, and User authentication using an assigned Secure Transaction Code and voice biometrics,” which is incorporated herein.

### BACKGROUND

Current transaction processing methods contain inherent security flaws, have extraneous dependencies on hardware, and are costly, cumbersome, and difficult to deploy. For example, Near Field Communication (NFC) chip cards and phones require stringent hardware interoperability and certification requirements; mobile payment schemes using quick response (QR) code schemes require special scanners to read and translate two-dimensional images; other mobile transaction processes require onerous keyboard input and use password or Personal Identification Number (PIN)-based processes that are subject to compromise. Further, current methods almost exclusively require the consumer to provide sensitive personal payment information to the merchant that can lead to identity theft. A better approach would enable the transaction to be processed without cumbersome or specialized hardware, and without disclosure of personal payment and authentication information that could be compromised and exploited in other channels.

Transaction “friction” is created when physical movement takes place in the transaction process. For example, use of a magnetic stripe payment card requires the User to swipe the card through a reader, approve the amount through manual entry on the transaction terminal, and provide a written signature. NFC payments substitute the card swipe by touching the terminal with a card. QR code payments require positioning a device in front of a reader and often assume possession of the QR Code-display device as a weak proxy for User authentication.

### SUMMARY

In an embodiment, a non-transitory computer readable medium that stores computer readable instructions, which when executed by at least one processor, implement a method for implementing a financial transaction via a user device is disclosed. The method involves receiving information regarding a financial transaction, generating a Secure Transaction Code from the received information, wherein the Secure Transaction Code is an alphanumeric value that binds the received information to the financial transaction, receiving information from a user device that includes a voice entry of the Secure Transaction Code, verifying that the voice entry of the Secure Transaction Code corresponds to a Voice Authentication Master (VAM) file of a registered user, obtaining the Secure Transaction Code from the information received from the user device, verifying that the Secure Transaction Code obtained from the information received from the user device is a valid Secure Transaction Code, if it is verified that voice entry of the Secure Transaction Code corresponds to a Voice Authentication Master file of a registered user and if the Secure Transaction Code is verified as a valid Secure Transaction Code, authorizing the financial transaction, and if the financial transaction is authorized, sending an indication that the financial transaction has been authorized to the user device.

In a second embodiment, a non-transitory computer readable medium that stores computer readable instructions, which when executed by at least one processor, implement a method for implementing a financial transaction between a merchant and a user of a mobile user device is disclosed. The method involves receiving information regarding a financial transaction from a merchant, generating a Secure Transaction Code from the received information, wherein the Secure Transaction Code is an alphanumeric value that binds the received information to the financial transaction, receiving information from a mobile user device that includes a voice entry of the Secure Transaction Code, verifying that the voice entry of the Secure Transaction Code corresponds to a Voice Authentication Master file of a registered user, obtaining the Secure Transaction Code from the information received from the mobile user device, verifying that the Secure Transaction Code obtained from the information received from the mobile user device is a valid Secure Transaction Code, if it is verified that the voice entry of the Secure Transaction Code corresponds to a master file of a registered user and if the Secure Transaction Code is verified as a valid Secure Transaction Code, authorizing the financial transaction between the merchant and the registered user, and if the financial transaction is authorized, sending an indication that the financial transaction has been authorized to the mobile user device.

In a third embodiment, a non-transitory computer readable medium that stores computer readable instructions, which when executed by at least one processor, implement a method for implementing a financial transaction between a merchant and a user of a mobile user device is disclosed. The method comprises receiving information from a mobile user device that includes a voice entry of a Secure Transaction Code, wherein the Secure Transaction Code is an alphanumeric value that is generated from information regarding a financial transaction and that binds the received information to the financial transaction, verifying that the voice entry of the Secure Transaction Code corresponds to a Voice Authentication Master file of a registered user, obtaining the Secure Transaction Code from the information received from the mobile user device, verifying that the Secure Transaction Code obtained from the information received from the user device is a valid Secure Transaction Code, if it is verified that the voice entry of the Secure Transaction Code corresponds to a master file of a registered user and if the Secure Transaction Code is verified as a valid Secure Transaction Code, authorizing the financial transaction between the merchant and the registered user, if the financial transaction is authorized, settling the financial transaction between the merchant and the registered user.

In a fourth embodiment, a non-transitory computer readable medium that stores computer readable instructions, which when executed by at least one processor, implement a method for secure access via a user device is disclosed. The method involves receiving information regarding an access request, generating a Secure Transaction Code from the received information, wherein the Secure Transaction Code is an alphanumeric value that binds the received information to the access request, receiving information from a user device that includes a voice entry of the Secure Transaction Code, verifying that the voice entry of the Secure Transaction Code corresponds to a Voice Authentication Master (VAM) file of a registered user, obtaining the Secure Transaction Code from the information received from the user device, verifying that the Secure Transaction Code obtained from the information received from the user device is a valid Secure Transaction Code, if it is verified that the voice entry of the Secure Transaction Code corresponds to a Voice Authentication Master file of a registered user and if the Secure Transaction Code is verified as a valid Secure Transaction Code, authorizing the access request and if the access request is authorized, sending an indication that the access request has been authorized to the user device.

In a fifth embodiment, a non-transitory computer readable medium that stores computer readable instructions, which when executed by at least one processor, implement a method for implementing a secure transaction via a user device is disclosed. The method involves receiving information regarding a secure transaction, generating a Secure Transaction Code from the received information, wherein the Secure Transaction Code is an alphanumeric value that binds the received information to the secure transaction, receiving verification information and the Secure Transaction Code from a user device, verifying that the verification information corresponds to verification information of a registered user, verifying that the Secure Transaction Code obtained from the user device is a valid Secure Transaction Code, if it is verified that the verification information corresponds to verification information of a registered user and if the Secure Transaction Code is verified as a valid Secure Transaction Code, authorizing the secure transaction and, if the financial transaction is authorized, sending an indication that the secure transaction has been authorized to the user device.

In an embodiment, the method described herein achieves its purpose without friction through the combination of three actions that provide a means for transaction identification, User authorization, and User authentication. The method requires the generation of a personalized transaction code (e.g., a secure message token) or “Secure Transaction Code” using a sophisticated algorithm by a central processor. The action of providing the Secure Transaction Code to an Origination Requester, and receiving the Secure Transaction Code from a User, serves to bind the Origination Requester and the User to the same transaction identification. The action of speaking and submitting the Secure Transaction Code by the User serves as User authorization. The action of verifying the User voice to a registered Voice Authentication Master File serves as User authentication.

In another embodiment, the Secure Transaction Code and verification of a User voice can be used to authenticate requests for secure access. Additionally, in another embodiment, the Secure Transaction Code can be used with other biometric identification (e.g., facial recognition, fingerprints, etc.) or with non-biometric identification (e.g., passwords, PINs, challenge/response mechanisms, etc.) to authenticate requests for secure access.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates transaction steps that occur between certain components to complete a financial transaction.

FIG. 2 illustrates an example of messages that are sent between the components to implement certain steps of the financial transaction technique of FIG. 1.

FIG. 3A corresponds to step 4 of FIG. 1 and depicts a point-of-sale device of the Origination Requestor that displays the Secure Transaction Code that is received from the Secure Transaction Code System.

FIG. 3B corresponds to step 5a of FIG. 1 and depicts a graphical user interface of the Application on the User Device.

FIG. 3C corresponds to step 5b of FIG. 1 and depicts a graphical user interface of the Application on the User Device.

FIG. 3D corresponds to step 6 of FIG. 1 and illustrates the User speaking the Secure Transaction Code into the User Device.

FIG. 3E corresponds to step 7 of FIG. 1 and depicts a graphical user interface of the

Application on the User Device.

FIG. 3F corresponds to step 15 of FIG. 1 and depicts a graphical user interface of the Application on the User Device.

FIG. 4 illustrates transaction steps that occur between certain components to complete an enrollment process that includes application installation, registration, and activation.

FIG. 5 is a table that illustrates the generation of a Secure Transaction Code. In an embodiment, the Origination Requester sends message 100 in FIG. 2 to the Secure Code System

FIG. 6 illustrates the transaction steps that occur between certain components to complete a financial transaction.

FIG. 7 illustrates an example of messages that are sent between the components to implement certain steps of the financial transaction technique of FIG. 6.

FIG. 8 is a table that further identifies the messages described above with reference to FIG. 7.

FIG. 9 is a table that illustrates an embodiment of the various message content components of each message described with reference to FIGS. 6-8.

FIG. 10 illustrates an example of messages that are sent between Users and components to implement certain steps of a financial transaction using a technique similar to the technique described with reference to FIGS. 1 and 6.

FIG. 11 is a block diagram of a User Device in accordance with an embodiment of the invention.

FIG. 12 is a block diagram of a system, such as a Secure Transaction Code/User Authentication System or a Secure Transaction Code/Bank Authentication/Voice Authentication System, in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

As stated, current transaction processing methods contain inherent security flaws, have extraneous dependencies on hardware, and are costly, cumbersome, and difficult to deploy. The transaction processing method described herein solves the existing problems through reduced dependency on hardware (e.g., specialized hardware), enhanced consumer usability, and vastly improved security using voice biometrics. The Origination Requester or merchant need not deploy additional hardware and the User may use an existing User Device like a smart phone. Personal consumer payment information or identification need not be presented to the merchant, eliminating the risks associated with personal information compromise, and emulating the same anonymity as cash, thereby creating a frictionless transaction between a user and a merchant.

The other existing solutions in the market or proposed are inconsistent, are not ubiquitously interoperable, and lack the most secure form of authentication if not using a reputable means of biometric for authentication. The method described herein differs from, and is an improvement of what currently exists, by using a highly-secure method for processing transactions using voice biometrics applied to a unique, perishable, one-time-use Secure Transaction Code; the combination of the User's voice, content of the spoken code, and code submission by the User provides a means for indisputable User authentication, identification to a specific transaction, and User transaction authorization, respectively.

In an embodiment, the method requires the generation of a personalized Secure Transaction Code using a sophisticated algorithm by a central processor. The action of providing the Secure Transaction Code to an Origination Requester, and receiving the Secure Transaction Code from a User within a defined time period, serves to bind the Origination Requester and the User to the same transaction identification. For example, the Secure Transaction Code binds the Origination Requester and the User to the same transaction identification because the Secure Transaction Code can be associated or correlated with specific details of the transaction such as the merchant ID, the transaction amount, the transaction date and time, etc. The action of speaking and submitting the Secure Transaction Code by the User serves as User authorization. The action of verifying the User voice with a registered Voice Authentication Master File serves as User authentication.

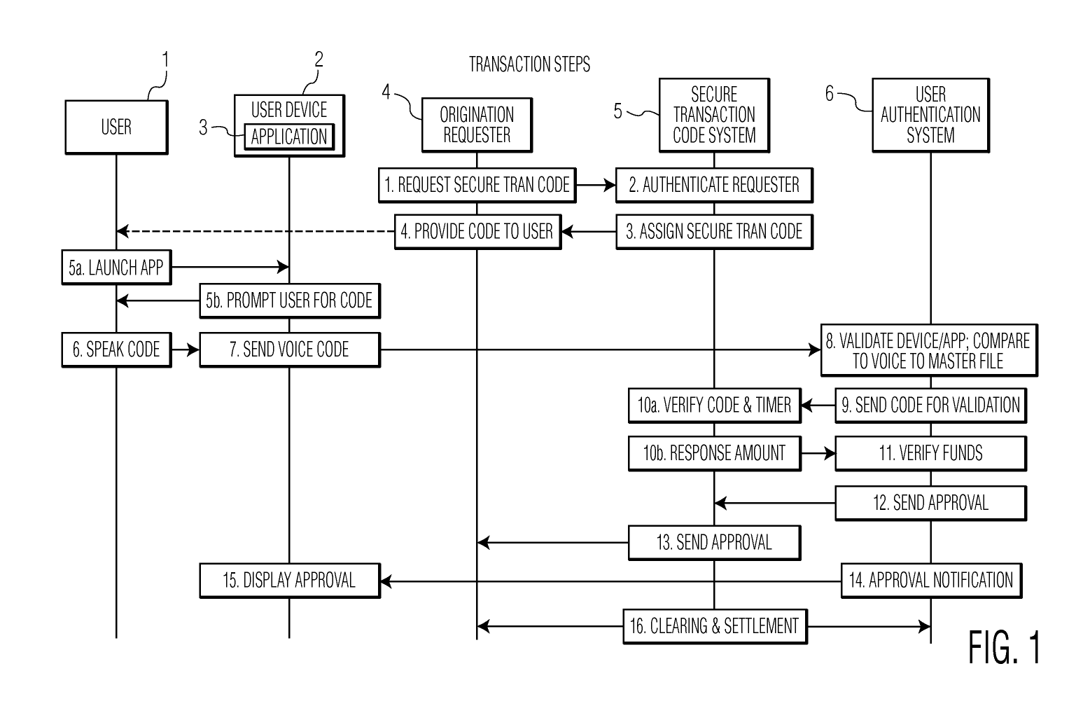

In an embodiment, a transaction processing method involves several different transaction steps that take place between several different components. FIG. 1 illustrates transaction steps that occur between certain components to complete a financial transaction. In the embodiment of FIG. 1, the components include a User 1, a User Device 2, a User Device Application 3, an Origination Requester 4, a Secure Transaction Code system 5, and a User Authentication System 6. In an embodiment, the components are as follows:

Component #1: User—Consumer or entity seeking to participate in a transaction and who provides an assigned Secure Transaction Code via voice entry and possibly other transaction input into the User Device.

Component #2: User Device—User electronic hardware, such as a smartphone, fitted with a microphone, used in conjunction with the User Device Application, for accepting and processing the User voice entry and transmitting to the User Authentication System. The User Device can be any of a variety of electronic form factors, including but not limited to phones, PDAs, music players, tablets, smart watches, smart glasses, and the like.

Component #3: User Device Application—Software personalized in The User Device that provides instruction, messaging, and processing of a transaction between the User and the User Authentication System.

Component #4: Origination Requester—Component or system such as a merchant, cashier or other originator who submits manual and/or electronic request for a Secure Transaction Code to effect a transaction. The Origination Requestor is responsible for communicating the assigned Secure Transaction Code to the User. In an embodiment, the User 1 can be an Origination Requester. In an embodiment, the Origination Requestor communicates the assigned Secure Transaction Code through a display on a point-of-sale device although other techniques are possible.

Component #5: Secure Transaction Code System—A system that generates unique, perishable, one-time-use Secure Transaction Codes to be used as basis for transaction identification, User authorization, and User authentication; also brokers transaction processing between the Origination Requester and the User Device Application.

Component #6: User Authentication System—A system that authenticates the User using the Secure Transaction Code and the User Device Application, and performs transaction authorization. The system also manages User registration, stores a Voice Authentication Master File, and manages User Device Application personalization and distribution.

Given the above-described components, steps involved in completing a financial transaction between the User and the Origination Requestor are described with reference to FIG. 1.

Step 1. Origination Requester 4 supplies transaction information (e.g., merchant ID, password, date, time and amount) to the Secure Transaction Code System 5 and requests a Secure Transaction Code.

Step 2. Secure Transaction Code System 5 authenticates Origination Requester 4 and generates a unique Secure Transaction Code using a secret algorithm. In an embodiment, the Secure Transaction Code can be an alphanumeric, numeric, or alphabetic code (hereinafter referred to as alphanumeric).

Step 3. Secure Transaction Code System 5 sends Secure Transaction Code to Origination Requester 4.

Step 4. Origination Requester 4 receives Secure Transaction Code and communicates transaction amount and Secure Transaction Code to User 5. For example, the Secure Transaction Code is displayed on a point-of-sale device at a merchant and made visible to the user. In another example, the Secure Transaction Code is displayed on an online merchant checkout page, or on a paper or electronic bill.

Step 5a. User 1 launches or accesses User Device Application 3 in User Device 2.

Step 5b. User Device Application 3 prompts User 1 to provide the Secure Transaction Code via voice entry into User Device 2.

Step 6. User 1 provides the Secure Transaction Code voice entry into the User Device 2 by speaking into the User Device microphone.

Step 7. User Device Application 3 processes the Secure Transaction Code voice entry and securely sends the Secure Transaction Code voice entry to the User Authentication System 6. In an embodiment, a voice translation module of the User Device translates the voice entry into an alphanumeric code and displays the alphanumeric code on a display of the user device so that the user can make sure that the alphanumeric code displayed on the user device matches the Secure Transaction Code displayed on the point-of-sale device of the origination requestor. In an embodiment, the user device then sends a digitized version of the analog voice entry to the User Authentication System 6. In another embodiment, the User Device also sends an alphanumeric version of the Secure Transaction Code to the User Authentication System. In another embodiment, the voice entry is transmitted directly to the User Authentication System via a real-time transmission channel without the User Device translating the voice entry into an alphanumeric code.

Step 8. User Authentication System 6 validates the User Device 2 and the User Device Application 3, and compares the Secure Transaction Code voice entry to a Voice Authentication Master File. For example, the User Device and User Device Application can be validated by device and application IDs and the digitized version of the analog voice entry can be validated by comparing the voice entry to a master voice file to determine if the digitized version of the analog voice entry matches the voice of the master voice file. Various techniques, as are known in the field of voice recognition, can be used to determine if there is a match.

Step 9. Upon successful match, the User Authentication System 6 converts the Secure Transaction Code to a message field that includes an alphanumeric representation of the Secure Transaction Code and sends the message to the Secure Transaction Code System 5 for validation.

Step 10a. Secure Transaction Code System 5 receives the message, matches the Secure Transaction Code for transaction identification and validates the code against a perishability timer. In an embodiment, a Secure Transaction Code is matched by locating the transaction record associated with the Secure Transaction code in the Secure Transaction Code System.

Step 10b. Secure Transaction Code System 5 sends transaction information including amount to User Authentication System 6.

Step 11. User Authentication System 6 verifies funds availability for User.

Step 12. User Authentication System 6 sends signed authorization message to Secure Transaction Code System 5.

Step 13. Secure Transaction Code System 5 sends signed authorization message of transaction approval to Origination Requester 4.

Step 14. User Authentication System 6 sends approval notification to User Device Application 3.

Step 15. User Device Application 3 displays transaction approval status on User Device 2 to User 1.

Step 16. Transaction is completed; clearing and settlement occur separately between Origination Requester 4 and User Authentication System 6 by Secure Transaction Code System 5.

In another embodiment, the above sequence of steps need not be processed in the exact order listed. For example, the transaction could be initiated in Step 5 in which the Secure Transaction Code System 5 assigns a unique Secure Transaction Code upon User Device Application 3 request, and matches the Secure Transaction Code to a message sent by the Origination Requester 4 in Step 1. Other embodiments are also possible.

In an embodiment, each successful use of the Secure Transaction Code Authentication process may be used to refine the Voice Authentication Master File for improved accuracy.

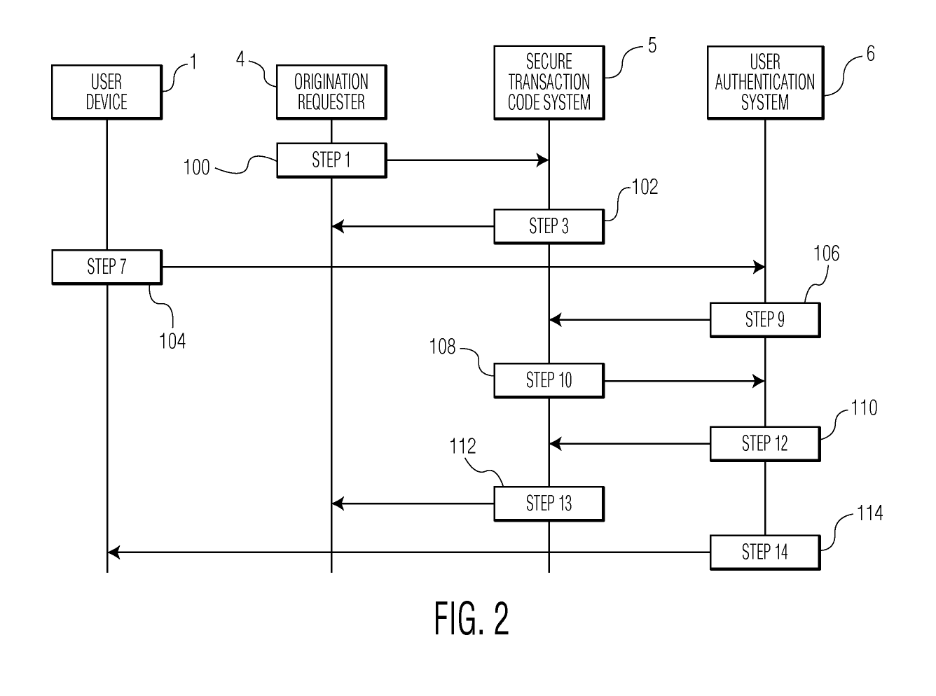

The technique described above with reference to FIG. 1 involves various message exchanges between the components. FIG. 2 illustrates an example of messages that are sent between the components to implement certain steps of the financial transaction technique of FIG. 1. The steps identified in FIG. 2 correspond to the steps illustrated in FIG. 1.

At step 1, a message 100 is transmitted from the Origination Requestor 4 to the Secure Transaction Code System 5. The message binds the Origination Requestor to the transaction and includes information such as a name, address, phone number, and password of the Origination Requestor as well as an ID, amount, time, and location of the transaction.

At step 3, a message 102 is transmitted from the Secure Transaction Code System 5 to the Origination Requestor 4. The message includes information such as the ID of the transaction to which the message is a response as well as a generated Secure Transaction Code.

At step 7, a message 104 is transmitted from the User Device 2 to the User Authentication System 6. The message binds the User Device to the transaction and includes information such as an IMEI number and an application ID as well as digitized analog voice data of the User speaking the Secure Transaction Code. The message may also include an alphanumeric version of the Secure Transaction Code that has been translated from the User's speaking of the Secure Transaction Code.

At step 9, a message 106 is transmitted from the User Authentication System 6 to the Secure Transaction Code System 5. The message includes information such as the IMEI number of the application ID as well as the Secure Transaction Code.

At step 10, a message 108 is transmitted from the Secure Transaction Code System 5 to the User Authentication System 6. The message includes information such as the Secure Transaction Code as well as Origination Requestor identification information (e.g., the name, address, phone number, and banking information), transaction information (e.g., transaction type and due date), location information, and the expiration time of the Secure Transaction Code.

At step 12, a message 110 is transmitted from the User Authentication System 6 to the Secure Transaction Code System 5. The message includes information such as the User transaction ID as well as financial information related to the transaction (e.g., the transaction amount, amount paid by the user, a final balance).

At step 13, a message 112 is transmitted from the Secure Transaction Code System 5 to the Origination Requestor 4. The message includes information such as the Origination Requestor identification information and financial information of the User.

At step 14, a message 114 is transmitted from the User Authentication System 6 to the User Device 2. The message includes information such as the Secure Transaction Code as well as the total amount paid and the name of the name of the Origination Requestor.

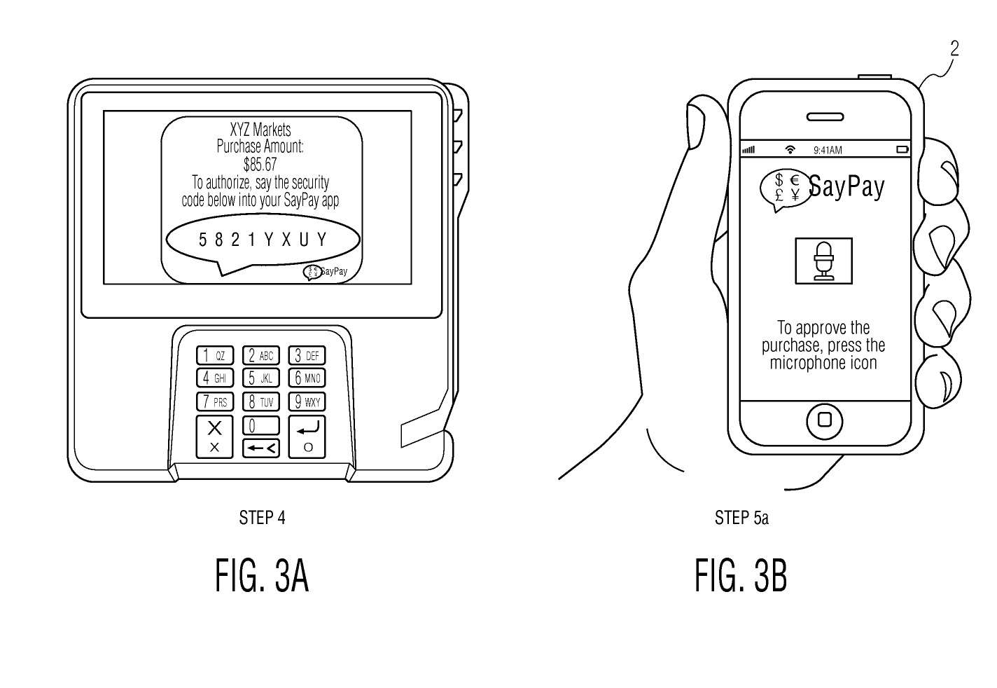

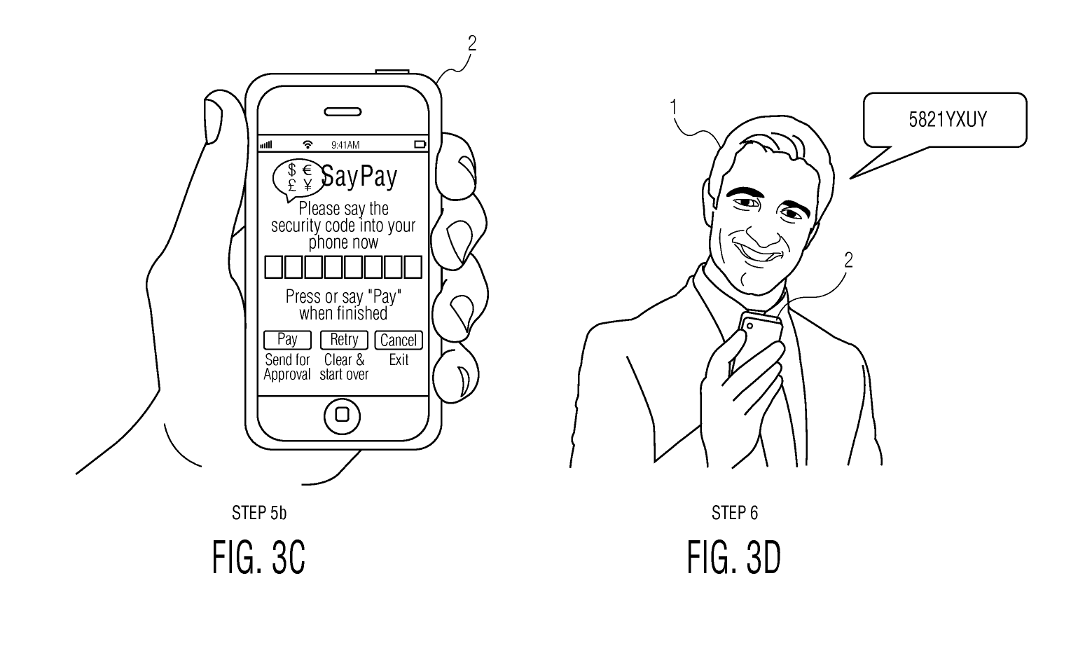

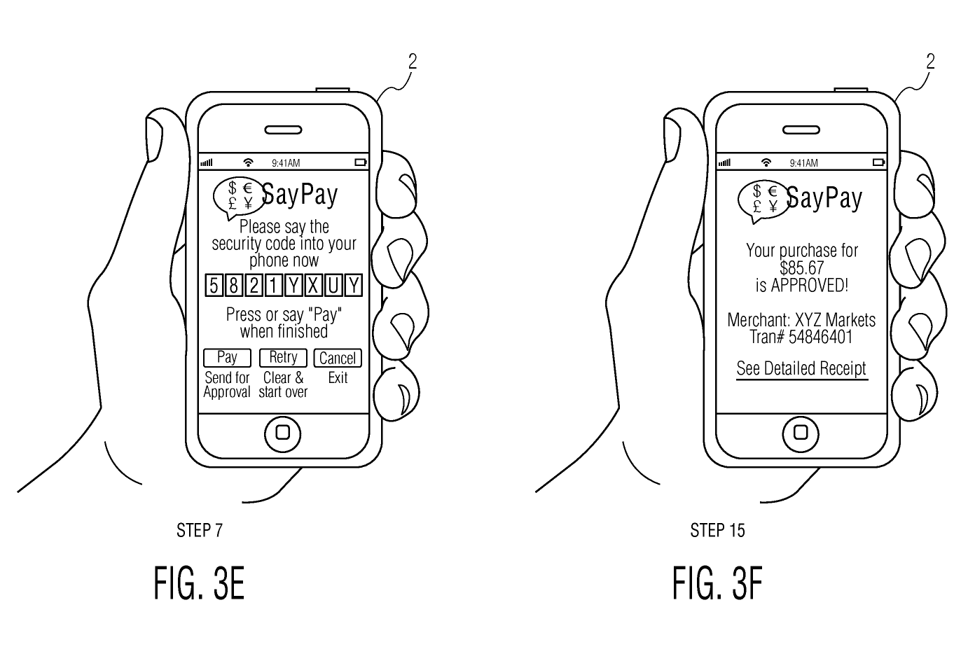

The technique described above with reference to FIGS. 1 and 2 is further illustrated with reference to FIGS. 3A—3F. The steps identified in FIGS. 3A—3F correspond to the steps illustrated in FIG. 1.

FIG. 3A corresponds to step 4 and depicts a point-of-sale device of the Origination Requestor 4 that displays the Secure Transaction Code that is received from the Secure Transaction Code System 5. As shown in FIG. 3A, the Secure Transaction Code of “5821YXUY” is displayed on the point-of-sale device. The point-of-sale device my also display other information related to the transaction such as the name of the Origination Requestor (e.g., “XYZ Markets”) and the transaction amount (e.g., “$85.67”).

FIG. 3B corresponds to step 5a and depicts a graphical user interface of the Application 3 on the User Device 2. As shown in FIG. 3B, the Application displays an introductory message to the User 1.

FIG. 3C corresponds to step 5b and depicts a graphical user interface of the Application 3 on the User Device 2. As shown in FIG. 3C, the graphical user interface prompts the User 1 to speak the Secure Transaction Code into the User Device. The graphical user interface also includes fields that correspond to individual digits of the alphanumeric code.

FIG. 3D corresponds to step 6 and illustrates the User 1 speaking the Secure Transaction Code (e.g., “5821YXUY”) into the User Device 2.

FIG. 3E corresponds to step 7 and depicts a graphical user interface of the Application 3 on the User Device 2. As shown in FIG. 3E, the graphical user interface includes the alphanumeric code that was spoken into the User Device entered into the corresponding fields of the graphical user interface. The graphical user interface also prompts the User 1 to initiate sending message 104 with the phrase “Press or say ‘Pay’ when finished.”

FIG. 3F corresponds to step 15 and depicts a graphical user interface of the Application 3 on the User Device 2. As shown in FIG. 3F, the graphical user interface includes information related to the financial transaction (e.g., receipt information) indicating that the transaction has been successfully completed. For example, the graphical user interface includes an indication that the transaction was approved, the merchant name, and a transaction number.

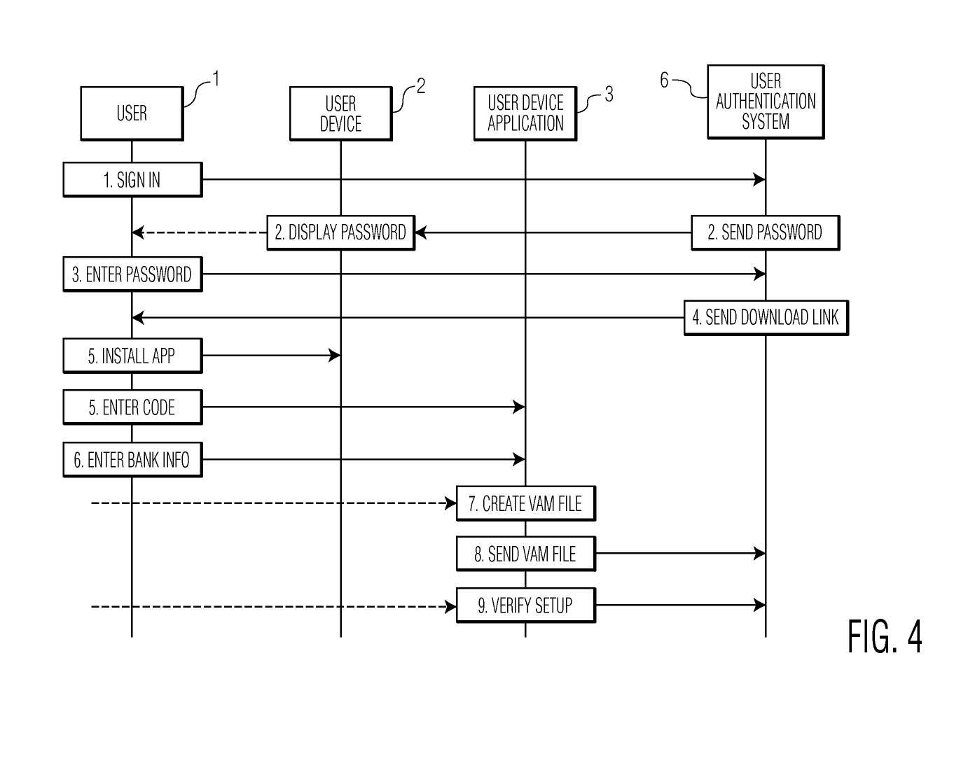

In an embodiment, participation in the above-described transaction technique requires the User 1 to install the Application 3 on the User Device 2 and enroll in the service to become a registered user. FIG. 4 illustrates transaction steps that occur between certain components to complete an enrollment process that includes application installation, registration, and activation. In the embodiment of FIG. 4, the components include the User 1, the User Device 2, the Application 3, and the User Authentication System 6 and the steps involved in completing an enrollment to become a registered user are described as follows:

Step 1. User 1 signs into the User Authentication System 6 website through User Device 2 to enroll and provides a User Device 2 identifier (e.g., a phone number or a user device ID such as an IMEI, ICCID, or IMSI).

Step 2. User Authentication System 6 sends one-time password (OTP) to User Device 2 for verification.

Step 3. User 1 enters OTP at website to confirm.

Step 4. User Authentication System 6 provides link to download User Device Application 3 to User Device 2 and Application Activation Code.

Step 5. User 1 installs User Device Application 3 (which may include a client certificate) and provides the Application Activation Code.

Step 6. User 1 enters bank User ID and password to sign in to configure and register for the service.

Step 7. User Device Application 3 prompts User 1 to vocally repeat 3 or more random sequences of representative numbers and letters into the User Device 2 to form a Voice Authentication Master (VAM) File. In another embodiment, less than 3 random sequences of representative numbers and letters can vocally repeated to form the VAM File. In an embodiment, a voice print can be taken from the vocalizations and stored in a VAM file associated with the User. Later, the acoustical qualities of a voice print taken from the User voice entry can be compared to the acoustical qualities of the voice print stored in the VAM file to authenticate the User.

Step 8. User Device Application 3 sends voice entries to User Authentication System 6 for processing and saving to VAM File.

Step 9. User Device Application 3 prompts User 1 through sample transaction workflow by generating test Secure Transaction Code, verifying test voice file to User Authentication System 6 using the Voice Authentication Master File; if successful, User Device Application 3 and Voice Authentication Master File are marked as active.

The sequence described above with reference to FIG. 4 provides one example of possible User Device Application installation, registration, and activation. Other ways for the User 1 to perform registration and activation may include registering over the phone via a voice call to a customer service agent, and creating a VAM File via an interactive voice response (IVR), personal computer, or other system capable of capturing voice biometrics.

In an embodiment, the technique for completing a financial transaction is described below with reference to the components and steps described with reference to FIGS. 1-3F. In an embodiment, a request generated by the Origination Requester 4 is an indication of a transaction attempt to be expected from a User 1. The request contains information about the transaction that is not known to the User Authentication System 6 but is important in processing the transaction, like the merchant name and transaction amount. The request also serves to validate that the Origination Requester 4 is an approved participant in the transaction and has provided information consistent with what is expected by the Secure Transaction Code System 5. The User Device 2 is the hardware interface between the User 1 and the User Device Application 3. The User Device stores the activated User Device Application 3 and it is responsible for display of User Device Application 3 instructions and for User 1 Voice Entry processing to the User Device Application 3. In an embodiment, the User Device is configured to implement computer-based voice translation (e.g., via speech recognition using Hidden Markov Models), which involves a computer processor translating a user's spoken works into alphanumeric values that can be displayed on the user device.

The User Device Application 3 provides the instruction, messaging, and processing of the transaction between the User Device 2 and the User Authentication System 6. The User Device Application 3 acts as a client to the User Authentication System 6 server, and provides local processing on behalf of the User Authentication System 6. In the embodiment of FIG. 1, the User Device Application 3 does not interface directly with the Origination Requester 4 or the Secure Transaction Code System 5. The User Authentication System 6 acts as a liaison between the User Device Application 3 and the Secure Transaction Code System 5. The User Authentication System validates a registered User Device 2 and User Device Application 3 via transaction information, authenticates the User 1 using the Voice Entry Secure Transaction Code, and performs transaction authorization (e.g., funds availability). The User Authentication System manages User registration, stores the Voice Authentication Master File, and manages User Device Application 3 distribution. When a User 1 sends a Secure Transaction Code through the User Device 2 and User Device Application 3, the User Authentication System 6 attempts to authenticate the User through his or her Voice Entry by, for example, comparing a voice footprint taken from the voice entry with a voice footprint in the VAM file associated with the User. When the User Authentication System 6 authenticates a User 1, submission of the transaction is assumed to be approved or “demanded” by the User 1. The combination of the User Device 2 ID, the User Device Application 3 ID, and the authenticated User 1 Voice Entry provide the User Authentication System 6 with the assurance that a registered User 1 used a legitimate User Device 2 through an activated User Device Application 3.

In an embodiment, the Secure Transaction Code System 5 acts as a broker between the Origination Requester 4 and the User Authentication System 6; the Secure Transaction Code System does not interface directly with the User 1, the User Device 2, or the User Device Application 3. The Secure Transaction Code System is responsible for generating the Secure Transaction Code, for ensuring legitimate participation by the Origination Requester 4, and providing transaction information to the User Authentication System 6. The Secure Transaction Code System 5 also validates the legitimacy of the transaction by matching the Secure Transaction Code value from the User Authentication System 6 to one in which the Secure Transaction Code System 5 generated within a specific time period (e.g., three minutes) for the Origination Requester 4. Each Secure Transaction Code is created using a secret algorithm that guarantees it to be genuine, unique, and irreversible. For example, the Secure Transaction Code is generated using an algorithm based on a merchant ID, a transaction ID, the current date and time, and the amount of the transaction as communicated by the initial transmission from the Origination Requester 4 to the Secure Transaction Code System 5. By using an algorithm based on information from the transaction, the resultant code is guaranteed to be the only code that could be generated for the transaction and, thus, the Secure Transaction Code binds the Origination Requester and the User to the specific transaction.

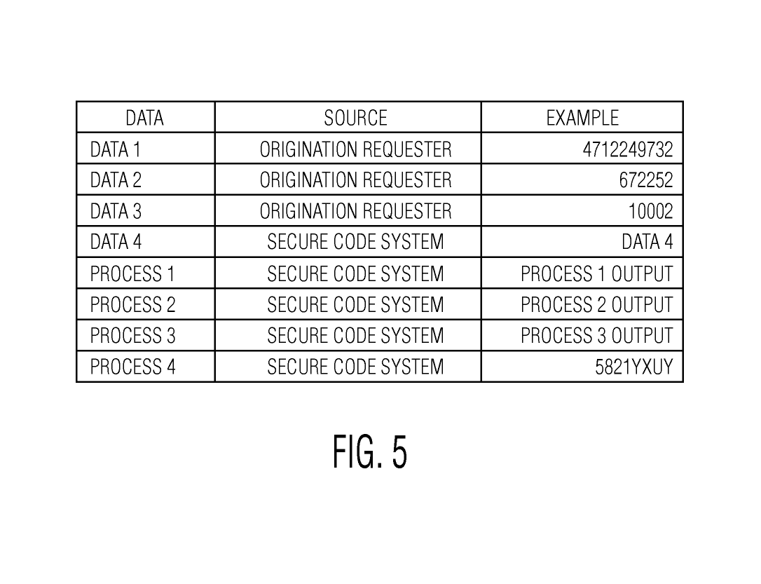

FIG. 5 is a table that illustrates the generation of a Secure Transaction Code. In an embodiment, the Origination Requester 4 sends message 100 (FIG. 2) to the Secure Transaction Code System 5. Then, as illustrated in FIG. 5, three data values are extracted from the message. In an embodiment, the first data value (Data 1) is the merchant ID (e.g., “4712249732”), the second data value (Data 2) is the transaction ID (e.g., “6772252”), and the third data value (Data 3) is the amount of the transaction (e.g., 100.02 indicated as “10002”). The Secure Transaction Code System uses the three data values plus some additional data (e.g., the current date and time) (Data 4) in a first process to generate a first output (Process 1 output). Three additional manipulations are performed (Process 2, Process 3, and Process 4) to generate a Secure

Transaction Code (e.g., “5821YXUY”). In an embodiment, Process 2 hashes the combination of Data 1, Data 2, Data 3, and Data 4, truncates the leading values of the hashed combination to the length of a Secure Transaction Code (e.g., 8-characters), and manipulates the truncated hashed combination by utilizing characters that are more easily distinguishable using voice authentication (e.g., R and K versus T and E).

In an embodiment, an 8-digit Secure Transaction Code is generated from a 16-digit base of hex characters. Using an 8-digit Secure Transaction Code generated from a 16-digit base of hex characters translates to approximately less than a 1:4.3 billion (16⁸=4,294,967,296) chance of ever generating the same Secure Transaction Code. The Secure Transaction Code is combined with a timer (making the Secure Transaction Code “perishable” after, for example, 900 seconds or 15 minutes) to reduce the chance of a stale Secure Transaction Code being used. In another embodiment, the Secure Transaction Code can be more or less than 8 digits.

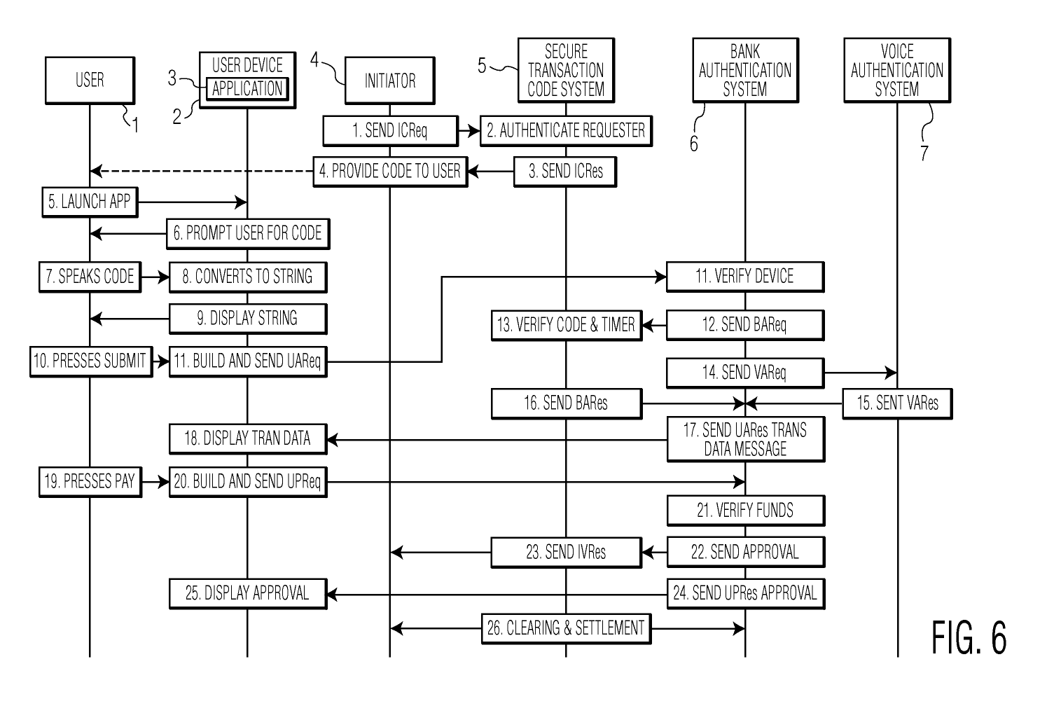

FIG. 6 illustrates another embodiment of transaction steps that occur between certain components to complete a financial transaction. In the embodiment of FIG. 6, the components include a User 1, a User Device 2, a User Device Application 3, an Initiator 4, a Secure Transaction Code System 5, a Bank Authentication System 6, and a Voice Authentication System 7. In an embodiment, the components are as follows:

Component #1: User—Consumer or entity seeking to participate in a transaction and who provides an assigned Secure Transaction Code via voice entry and possibly other transaction input into User Device.

Component #2: User Device—User electronic hardware, such as a smartphone, fitted with a microphone, used in conjunction with User Device Application, for accepting and processing a User voice entry and transmitting the User voce entry to the Bank Authentication System. The User Device can be any of a variety of electronic form factors, including but not limited to phones, PDAs, music players, tablets, smart watches, smart glasses, and the like.

Component #3: User Device Application—Software personalized in User Device that provides instruction, messaging, and processing of transaction between User and Bank Authentication System.

Component #4: Initiator—Component or system such as a merchant, cashier or other originator who submits manual and/or electronic request for a Secure Transaction Code to effect a transaction. The Initiator is responsible for communicating the assigned Secure Transaction Code to the User.

Component #5: Secure Transaction System—A system that generates unique, perishable, one-time-use Secure Transaction Code to be used as basis for transaction identification, User authorization, and User authentication; also brokers transaction processing between the Initiator and the User Device Application.

Component #6: Bank Authentication System—A system that authenticates the User using the Secure Transaction Code and the User Device Application, and performs transaction authorization. The system also manages User registration and manages User Device Application personalization and distribution. In an embodiment, the Bank Authentication System can be performed by a bank using the described technique or by a third-party.

Component #7: Voice Authentication System—A system that biometrically authenticates the User voice entry received from the Bank Authentication System. The system also stores a Voice Authentication Master File (VAM file) of registered users. For example, the Voice Authentication System can perform voice authentication by comparing the acoustical qualities of the User voice entry against expected acoustical qualities according to the VAM file. In other embodiments, the Voice Authentication System can be implemented as part of the Bank Authentication System or by a third-party voice recognition system.

Given the above-described components, steps involved in completing a financial transaction between the User and the Initiator are described with reference to FIG. 6.

Step 1. Initiator 4 supplies transaction information (e.g., merchant ID, password, date, time, and amount) to the Secure Transaction System 5 and requests a Secure Transaction Code.

Step 2. Secure Transaction System 5 authenticates Initiator 4 and generates a unique Secure Transaction Code using a secret algorithm.

Step 3. Secure Transaction System 5 sends Secure Transaction Code to Initiator 4.

Step 4. Initiator 4 receives Secure Transaction Code and communicates transaction amount and Secure Transaction Code to User 1. For example, the Secure Transaction Code is displayed on a point-of-sale device at a merchant and made visible to the user.

Step 5. User 1 launches or accesses User Device Application 3 in User Device 2.

Step 6. User Device Application 3 prompts User 1 to provide the Secure Transaction Code via voice entry into User Device 2.

Step 7. User 1 provides the Secure Transaction Code voice entry into User Device 2 by speaking into the User Device microphone.

Step 8. User Device Application 3 processes the voice entry and converts the spoken Secure Transaction Code to a value.

Step 9. User Device Application 3 displays the value on the display of the User Device 2.

Step 10. User 1 presses “submit” on the display of the User Device 2.

Step 11. User Device Application 3 builds a user authentication request message and the User Device 2 transmits the message to the Bank Authentication System 6, which verifies the User Device 2.

Step 12. Bank Authentication System 6 sends a request message to the Secure Transaction System 5 to verify the Secure Transaction Code.

Step 13. Secure Transaction System 5 verifies the Secure Transaction Code and determines if the message in Step 11 was sent within an acceptable time window after the creation of the Secure Transmission Code was generated in Step 2.

Step 14. Bank Authentication System 5 sends the voice entry to Voice Authentication System 7.

Step 15. Voice Authentication System authenticates the voice entry against the VAM files for registered users and returns the results of the authentication back to Bank Authentication System 6. In an embodiment, the authentication is performed by a computer-based comparison of the acoustical qualities of a voice print taken from a User voice entry against the acoustical qualities of the voice print stored in the VAM file associated with the User.

Step 16. Secure Transaction System 5 verifies the Secure Transaction Code and time window and returns the results of the verification to the Bank Authentication System 6.

Step 17. Bank Authentication System 6 transmits the results of steps 15 and 16 as well as transaction data to the User Device 2.

Step 18. User Device Application 3 processes the transmission from Step 17 and displays the information on the display of the User Device 2.

Step 19. User 1 presses “pay” to confirm validity of the transaction data and to confirm payment.

Step 20. User Device Application 3 builds a user payment request message and the User Device 2 transmits the message to Bank Authentication System 6.

Step 21. Bank Authentication System 6 verifies that the user has sufficient funds to complete the transaction.

Step 22. Bank Authentication System 6 sends the results of Step 21 to Secure Transaction System 5.

Step 23. Secure Transaction System 5 sends the results of Step 21 to Initiator 4.

Step 24. Bank Authentication System 6 sends the results of Step 21 to User Device 2.

Step 25. User Device Application 3 processes the results of Step 21 and displays the results on the display of User Device 2.

Step 26. Secure Transaction System 5 clears the transaction and sends settlement notices to Initiator 4 and Bank Authentication System 6.

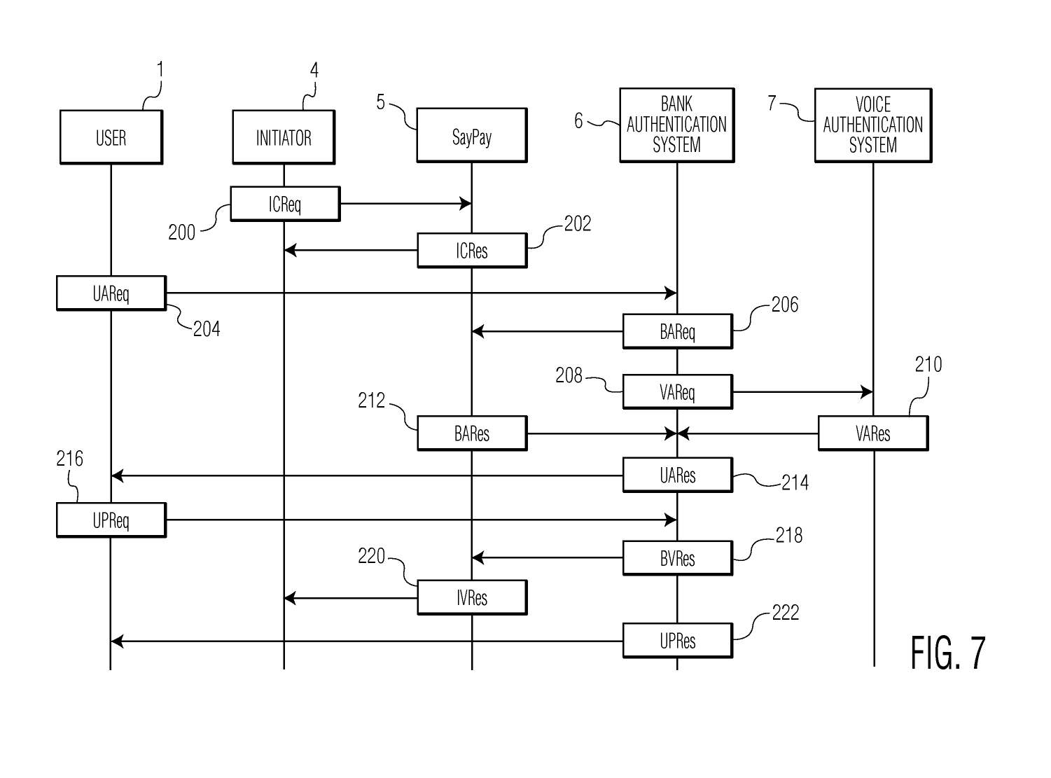

The technique described above with reference to FIG. 6 involves various message exchanges between the components. FIG. 7 illustrates an example of messages that are sent between the components to implement certain steps of the financial transaction technique of FIG. 6. The messages identified in FIG. 7 correspond to the steps illustrated in FIG. 6.

Message 200 is a message transmitted from the Initiator 4 to the Secure Transaction System 5. The message includes information such as a name, address, phone number, and password of the Initiator as well as an ID, amount, time, and location of the transaction. In an embodiment, the information in message 200 can be used to generate the Secure Transaction Code. In an embodiment, the information in message 200 can be used to generate the Secure Transaction Code.

Message 202 is a message transmitted from the Secure Transaction System 5 to the Initiator 4. The message includes information such as the ID of the transaction to which the message is a response as well as a generated Secure Transaction Code.

Message 204 is a message transmitted from the User Device 2 to the Bank Authentication System 6. The message includes information such as an IMEI number and an application ID as well as digitized analog voice data and the Secure Transaction Code.

Message 206 is a message transmitted from the Bank Authentication System 6 to the Secure Transaction System 5. The message includes information such as the IMEI number of the application ID as well as the Secure Transaction Code.

Message 208 is a message transmitted from the Bank Authentication System 6 to the Voice Authentication System 7. The message includes information such as the Secure Transaction Code and the user voice entry.

Message 210 is a message transmitted from the Voice Authentication System 7 to the Bank Authentication System 6. The message includes information such as the Secure Transaction Code and the results of the authentication of the user voice entry against the VAM files for registered users.

Message 212 is a message transmitted from the Secure Transaction System 5 to the Bank Authentication System 6. The message includes information such as the Secure Transaction Code as well as Initiator identification information (e.g., the name, address, phone number, and banking information), transaction information (e.g., transaction type and due date), location information, and the expiration time of the Secure Transaction Code.

Message 214 is a message transmitted from the Bank Authentication System 6 to the User 1. The message includes information such as the Secure Transaction Code and transaction information (e.g., Initiator name, due date, transaction amount).

Message 216 is a message transmitted from the User 1 to the Bank Authentication System 6. The message includes information such as the Secure Transaction Code, user information (e.g., a user transaction ID, date and time, location of the user) and user payment information (e.g., amount due, amount to be paid by user, final amount due).

Message 218 is a message transmitted from the Bank Authentication System 6 to the Secure Transaction System 5. The message includes information such as the User transaction ID as well as financial information related to the transaction (e.g., the transaction amount, amount paid by the user, a final amount due).

Message 220 is transmitted from the Secure Transaction System 5 to the Initiator 4. The message includes information such as the Initiator identification information and financial information of the User (e.g., the amount paid by the user and a final amount due).

Message 222 is transmitted from the Bank Authentication System 6 to the User 1. The message includes information such as the Secure Transaction Code as well as the total amount paid and the name of the name of the Initiator.

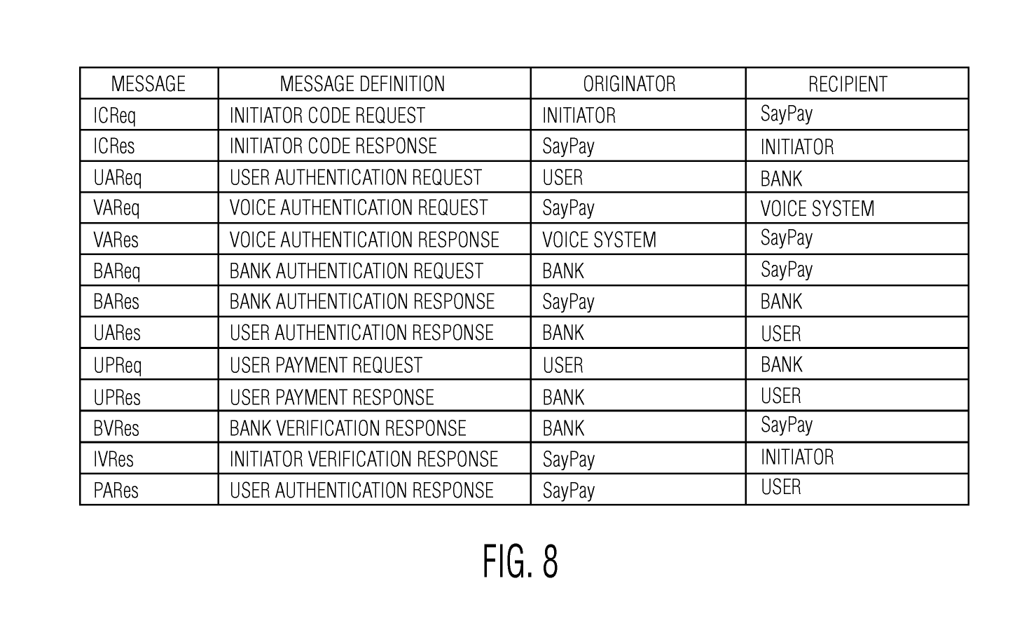

The messages described above with reference to FIG. 7 are further identified in the table of FIG. 8. In an embodiment, the messages described with reference to FIG. 7 are as follows: Message 200 is an Initiator Code Request (ICReq) message sent from the Initiator 4 to the Secure Transaction System 5. Message 202 is an Initiator Code Response (ICRes) message sent from the Secure Transaction System 5 to the Initiator 4. Message 204 is a User Authentication Request (UAReq) message sent from the User 1 to the Bank Authentication System 6. Message 206 is a Bank Authentication Request (BAReq) message that is sent from the Bank Authentication System 6 to the Secure Transaction System 5. Message 208 is a Voice Authentication Request (VAReq) sent from the Bank Authentication System 6 to the Voice Authentication System 7. Message 210 is a Voice Authentication Response (VARes) message sent from the Voice Authentication System 7 to the Bank Authentication System 6. Message 212 is a Bank Authentication Response (BARes) message sent from the Secure Transaction System 5 to the Bank Authentication System 6. Message 214 is a User Authentication Response (UARes) message sent from the Bank Authentication System 6 to the User 1. Message 216 is a User Payment Request (UPReq) message sent from the User 1 to the Bank Authentication System 6. Message 218 is a Bank Verification Response (BVRes) message sent from the Bank Authentication System 6 to the Secure Transaction System 5. Message 220 is an Initiator Verification Response (IVRes) message that is sent from the Secure Transaction System 5 to the Initiator 4. Message 222 is a User Payment Response (UPRes) sent from the Bank Authentication System 6 to the User 1.

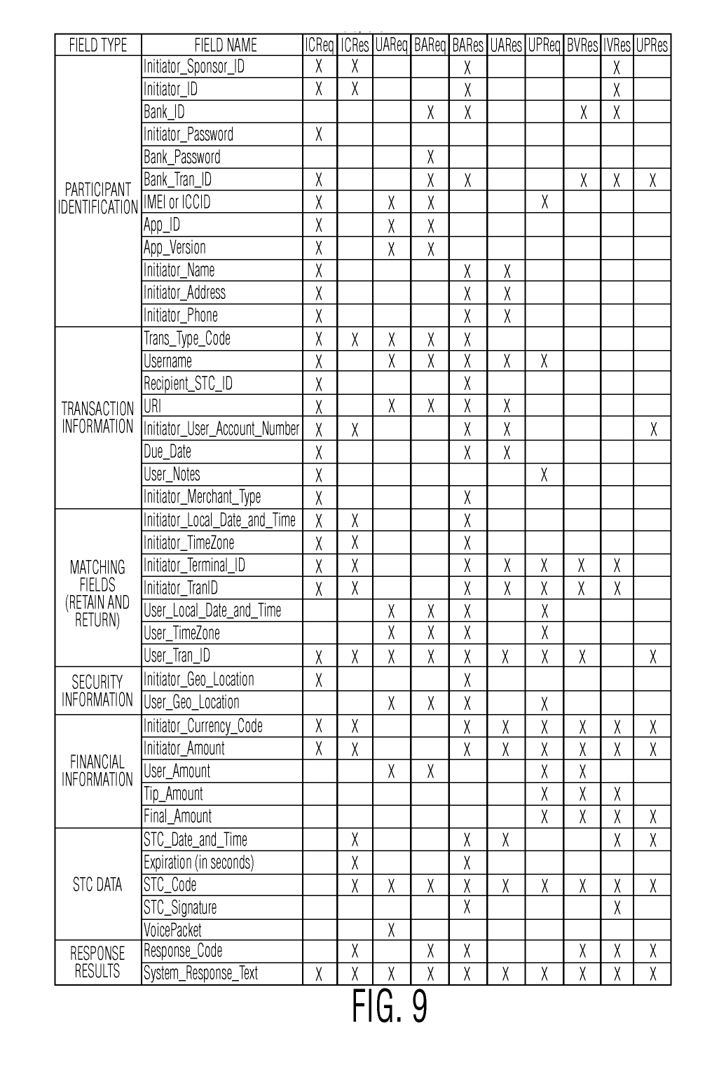

In an embodiment, the messages described above with reference to FIGS. 6-8 are made up of specific message content components. FIG. 9 is a table that illustrates an embodiment of the various message content components of each message. In FIG. 9, the message content components are divided into categories of participant identification, transaction information, matching fields, security information, financial information, STC Data, and Response Results. In an embodiment, the participant identification message content components are as follows:

Initiator_Sponsor_ID—A unique identification number associated with a sponsor or company to which the Initiator belongs.

Initiator_ID—A unique identification number associated with the party to a transaction that initiates the transaction.

Bank_ID—A unique identification number associated with the bank of the Initiator.

Initiator_Password—A password used by the Initiator to authenticate identify with the Secure Transaction System.

Bank_Password—A password used by the Bank to authenticate identify with the Secure Transaction System.

Bank_Tran_ID—A unique identification number associated by the bank with the record of the transaction.

IMEI or ICCID—International Mobile Station Equipment Identity (IMEI), Integrated Circuit Card identifier (ICCID), or International Mobile Subscriber Identify (IMSI) identifying the User Device.

App_ID—A unique identification number associated with the User Device Application.

App_Version—Version number of the Application that is running on the User Device.

Initiator_Name—The name of the party initiating the transaction.

Initiator_Address—The address of the party initiating the transaction.

Initiator_Phone—The phone number of the party initiating the transaction.

In an embodiment, the transaction information message content components are as follows:

Trans_Type_Code—a code that indicates the type of the transaction (e.g., commercial or person-to-person)

Username—A unique word or string used to identify the Initiator, the Bank, and the User.

Recipient_STC_ID—A unique identification number associated with the Initiator. URI—A string of characters used to identify the Initiator, Bank, and User.

Initiator_User_Account_Number—A unique identification number associated with a funding depository of the Initiator.

Due_Date—The date on which the payment is or by which it must be made.

User_notes—Additional text description of the transaction generated by the User.

Initiator_Merchant_Type—A code that indicates the Merchant Type of the Initiator (e.g., internet, physical, individual).

In an embodiment, the matching fields message content components are as follows:

Initiator_Local_Date_and_Time—The local date and time at which the Initiator initiated the transaction.

Initiator_TimeZone—The time zone in which the Initiator initiated the transaction.

Initiator_Terminal_ID—A unique identification number associated with a payment terminal of the Initiator.

Initiator_TranID—A unique identification number associated by the Initiator with a record of the transaction.

User_Local_Date_and_Time—the local date and time at which the User authorizes payment to the Initiator.

User_TimeZone—the time zone in which the User authorized payment.

User_Tran_ID—A unique identification number associated by the User with a record of the transaction.

In an embodiment, security information message content components are as follows:

Initiator_Geo_Location—The physical global location of the Initiator when the transaction is initiated.

User_Geo_Location—The physical global location of the User when the User authorizes payment to the Initiator.

In an embodiment, financial information message content components are as follows:

Initiator_Currency_Code—A code that indicates the currency used in the transaction (e.g., U.S. Dollars, Euros, Yen, Bit-Coin)

Initiator_Amount—The amount the Initiator would like to receive from the User.

User_Amount—The amount of the bill the User will pay the Initiator.

Tip_Amount—An additional amount the User wishes to pay to the Initiator.

Final_Amount—The total amount of money the User pays to the Initiator.

In an embodiment, STC Data message content components are as follows:

STC_Date_and_Time—The date and time the transaction request was received by the Secure Transaction System from the Initiator.

Expiration—The amount of time (in seconds) before the generated Secure Transaction Code will become invalid.

STC_Code—the generated Secure Transaction Code.

STC_Signature—an electronic cryptographic hash value that identifies the Secure Transaction Code System as the source of the Secure Transaction Code.

VoicePacket—A digitized version of an analog voice recording of the spoken Secure Transaction Code. In an embodiment, the VoicePacket can be transmitted as the result of communications over a real-time communications channel.

In an embodiment, response results message content components are as follows:

Response_Code—A code that indicates a message is a response message.

System_Response_Text—A text field identifying the message type.

In an embodiment, the Secure Transaction Code can be generated using any combination of the information included in the ICReq message as indicated by the corresponding ‘X’ marks in FIG. 9.

In an embodiment, the above-described techniques provide secure financial transactions for at least the following reasons.

1. The successful transaction process requires availability of all components (1-6), interacting in a defined set of sequences, including communication networks.

2. Only components (1-6) eligible for participation may process successful transactions; component participation is validated via various authentication forms and methods.

3. User 1 enrollment is required prior to successful transaction participation, including installation, registration and activation of the User Device Application 3.

4. If the Origination Requester 4 is not enrolled for participation, then the Secure Transaction Code System 5 rejects the request with an error code.

5. If the Origination Requester 4 does not supply expected transaction information, then the Secure Transaction Code System 5 may reject the request with an error code.

6. If the User 1 voice entry of the Secure Transaction Code cannot be verified against the User's Voice Authentication Master File by the User Authentication System 6, then the transaction attempt via voice entry is declined.

7. If the Secure Transaction Code System 5 cannot deliver the transaction approval to the Origination Requester 4, then the transaction may be canceled and a new transaction initiated.

8. If the User Device 2 cannot accept a voice entry due to background noise, microphone malfunction, and the like, then the transaction may be submitted by the User 1 keying the Secure Transaction Code into the User Device 2 keypad with a password.

9. If User 1 request exceeds the timer for the Secure Transaction Code submission to the Secure Transaction Code System, then the transaction is declined.

In an embodiment, a financial transaction can be accomplished between a User and an Origination Requestor (e.g., a merchant) using the above-described technique without any signals being exchanged between the User's User Device and a point-of-sale device of the Origination Requestor. For example, a person can make a purchase using their smartphone at a merchant without their smartphone exchanging any signals (e.g., electromagnetic, radio frequency, optical, etc.) with the merchant's point-of-sale device. Thus, a completely “frictionless” transaction is achieved between the User and the Origination Requestor at the point-of-sale.

In an embodiment, implementation of the above-described techniques utilizes knowledge of advanced financial transaction processing, security design, client-server and web service architectures, voice biometric authentication, message construction and processing, database data models, network connectivity and protocols, X.509 Certification Authority functionality, and User Device application development, deployment and operations.

In an embodiment, all components shown in the figures are utilized in some way to implement the technique; the User Device 2 and User Device Application 3 can be combined as an integrated component. The User Device Application 3 may optionally include an amount input via voice entry or manually key-entered. A mechanism for processing exception conditions may be via key-entry of the Secure Transaction Code, Amount, and a password.

In an embodiment, the messages could be processed using XML message structure or embedded within industry standard ISO 8583 message payload.

In an embodiment, the Origination Requester 4 requires developing functionality for submitting a request message containing Origination Requester 4 information like client certificate, Origination Requester 4 ID, password, local time and date, location, terminal ID, IP Address, etc. and receiving a response message from the Secure Transaction Code System 5 containing the Secure Transaction Code and a timestamp. The Origination Requester 4 must also provide a means for communicating the Secure Transaction Code to the User 1 through such means as terminal display, printed copy, or verbally.

In an embodiment, the User Device 2 requires functionality consisting of a User 1 display, microphone, network connectivity, local client certificate storage and processing, and local application processing from an operating system.

In an embodiment, the User Device Application 3 requires developing functionality including code development for deployment in various User Device 2 operating systems and logic for registering the Application with the User Device 2 and User 1 account in the User Authentication System 6. The Application must be capable of making a secure network connection using a client certificate to the User Authentication System 6, forming a message that contains transaction information including User Device 2 details, a User 1 Voice Entry file, and reading information from the User Device 2 like device ID, local time and date, geographic coordinates, etc. The User Authentication System 6 requires developing functionality to register and verify/authenticate a User 1 Voice Entry, User Device 2, and User Device Application 3, accept and process certificates and messages to and from the User Device Application 3, and parse and send certificates and messages to and from the Secure Transaction Code System 5. In an embodiment, the User Authentication System 6 also deploys the User Device Application 3 to the User Device 2.

In an embodiment, the Secure Transaction Code System 5 requires developing functionality to register and verify/authenticate Origination Requester 4 information via certificate and request messages, generating and sending response messages containing the transaction Secure Transaction Code according to a secret algorithm to the Origination Requester 4, setting and calculating a transaction timer, verifying the User Authentication System 6, generating and sending messages containing transaction information including the Origination Requester 4 information and transaction amount to the User Authentication System 6.

The above-described techniques could be deployed for a variety of financial and non-financial transaction uses. Financial transaction uses may include but are not limited to Retail purchases, Account transfers, P2P via User Devices, Mail Order Telephone Order (MOTO), e-Commerce/m-Commerce, Consumer Bill Payments, Cardless ATM Withdrawals, Step-up Authentication, and Corporate Collections and Payments. Non-financial transaction uses and secure access uses may include information exchange, such as an online vault, a permission system (e.g., a secure website), or classified data access. In an embodiment, the Origination Requestor 4 may include a website in which the Secure Transaction Code is provided to the User via a personal computer or a company that is generating bills (e.g., paper or electronic) in which the Secure Transaction Code is included on or with the bill.

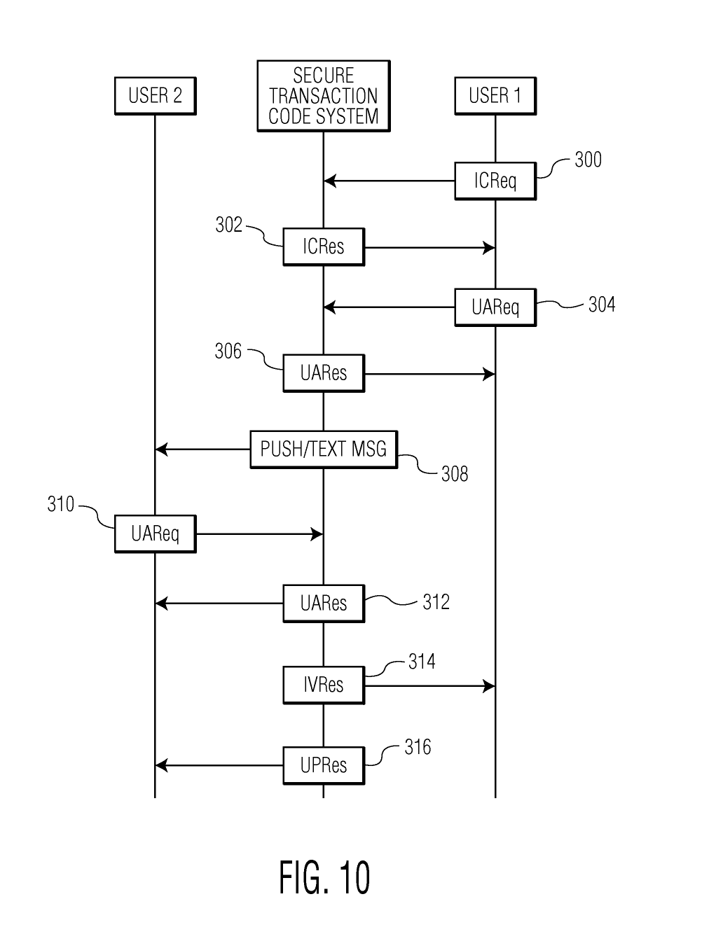

The above-described techniques could also be deployed to send a payment between two Users. FIG. 10 illustrates an example of messages that are sent between Users and components to implement certain steps of a financial transaction using a technique similar to the technique described with reference to FIG. 1 and FIG. 6. The messages identified in FIG. 10 correspond to steps of the above-described techniques.

Message 300 is a message transmitted from a first User (User 1) to a Secure Transaction Code System. The message initiates the transaction and includes information such as a name, address, phone number, and password of User 1 as well as an ID, amount, time, and location of the transaction.

Message 302 is a message transmitted from the Secure Transaction System to the first user (User 1). The message acknowledges the initiation of the transaction and includes information such as the ID of the transaction to which the message is a response as well as a generated Secure Transaction Code, which is generated using any combination of the information included in the ICReq message as indicated in FIG. 9.

Message 304 is a message transmitted from the first user (User 1) to the Secure Transaction System. The message sends information needed for authentication and includes information such as an IMEI number and an application ID as well as digitized analog voice data and the Secure Transaction code.

Message 306 is a message transmitted from the Secure Transaction System to the first user (User 1). The message confirms the authentication and includes information such as the Secure Transaction Code and transaction information (e.g., name of User 1, due date, and transaction amount).

Message 308 is a message sent from the Secure Transaction System to a second User (User 2). The message is a text or push message that notifies the second user of the transaction. The message includes information to identify the transaction (e.g., name of User 1, the amount of the transaction, the cause of the transaction) as well as the generated Secure Transaction Code.

Message 310 is a message transmitted from the second user (User 2) to the Secure Transaction System. The message acknowledges the transaction and provides authentication information including information such as an IMEI number and application ID as well as digitized analog voice data and the Secure Transaction Code. In another embodiment, the message 310 may not include a translated version of the Secure Transaction Code such that the Secure Transaction Code must be translated by the Secure Transaction Code System from the analog voice data.

Message 312 is a message transmitted from the Secure Transaction System to the second user (User 2). The message acknowledges authentication and includes information such as the Secure Transaction Code and transaction information.

Message 314 is a message transmitted from the Secure Transaction Code System to the first user (User 1). The message notifies the first user of the acknowledgement of the second user and includes information such as identification information for the first user (User 1) and financial information regarding the transaction (e.g., the total amount paid by the first user to the second user).

Message 316 is a message from the Secure Transaction Code System to the second User (User 2). The message confirms the transfer of funds and includes information such as the Secure Transaction Code as well as the total amount received and the name of the first User (User 1).

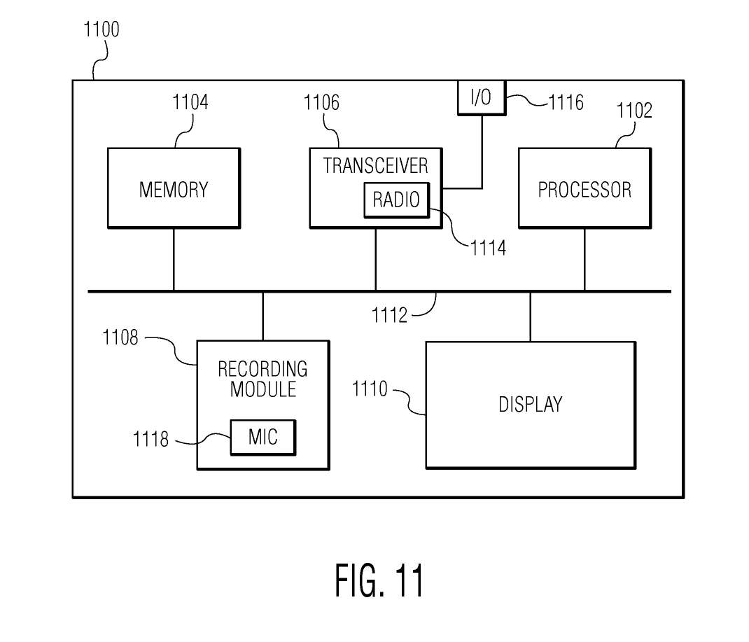

FIG. 11 is a block diagram of a User Device 1100 in accordance with an embodiment of the invention. The User Device includes a processor 1102 and memory 1104, a transceiver 1106, a recording module 1108, and a display 1110 that are interconnected by a data bus 1112. In an embodiment, the transceiver can utilize a radio 1114 (e.g., Wi-Fi, Bluetooth, NFC) and/or the transceiver can utilize a physical input/output interface 1116 (e.g., USB, Firewire, Ethernet). In an embodiment, the recording module has a microphone 1118 that is used for accepting and processing User voice entries, which are then processed by the processor and transmitted by the transceiver. For example, when a User reads a Secure Transaction Code aloud, the recording module will record the vocalization with the microphone, which is then processed and transmitted. In an embodiment, the transceiver communicates with a Secure Transaction Code System and a User Authentication System as described above. In an embodiment, the processor and memory are configured to display a translated value of the recorded Secure Transaction Code. For example, when the User reads a Secure Transaction Code aloud, the spoken code is translated by the processor and memory and displayed as text on the display for visual confirmation. In an additional embodiment, the display can display the Secure Transaction Code for the User to read aloud.

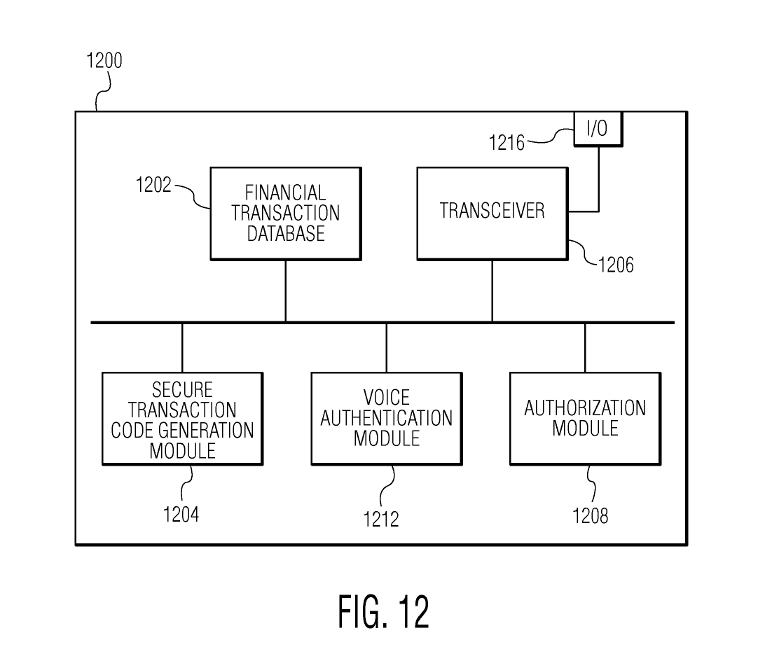

FIG. 12 is a block diagram of a system, such as a Secure Transaction Code/User Authentication System or a Secure Transaction Code/Bank Authentication/Voice Authentication System, in accordance with an embodiment of the invention. The system 1200 includes a transceiver 1206, a voice authentication module 1212, a Secure Transaction Code generation module 1204, a financial transaction database 1202, and an authorization module 1208. The transceiver can facilitate communication via a physical input/output interface 1216 (e.g., USB, Firewire, Ethernet). The system may also include at least one processor and memory to execute computer readable instructions to implement the above-described techniques. In accordance with an embodiment of the invention, when a request to initiate a transaction is received by the system, a Secure Transaction Code is generated by the Secure Transaction Code generation module, sent to a User, and stored in a new entry in the financial transaction database. In response to sending the Secure Transaction Code to the User, a voice entry is received and authenticated by the voice authentication module. In various embodiments of the system, components of the system can be excluded as needed. In an embodiment, the system of FIG. 12 is implemented on a computer server.

A transaction processing method that binds User authentication, transaction identification, and User authorization using a Secure Transaction Code and voice biometrics is disclosed. In an embodiment, the method achieves its purpose through the combination of three actions that provide a means for transaction identification, User authorization, and User authentication. In an embodiment, the method requires the generation of a personalized Secure Transaction Code using a sophisticated algorithm by a central processor. The action of providing the transaction code to an Origination Requester, and receiving the transaction code from a User, serves to bind Origination Requester and sender to the same transaction identification. The action of speaking and submitting the code by the transaction recipient for processing serves as User authorization. The action of verifying the User voice to a registered Voice Authentication Master File serves as User authentication.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing computer executable instructions, or program code, for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A non-transitory computer readable medium that stores computer readable instructions, which when executed by at least one processor, implement a method for implementing a financial transaction via a user device, the method comprising:
receiving information regarding a financial transaction;
generating a Secure Transaction Code from the received information, wherein the Secure Transaction Code is an alphanumeric value that binds the received information to the financial transaction;
receiving information from a user device that includes a voice entry of the Secure Transaction Code;
verifying that the voice entry of the Secure Transaction Code corresponds to a Voice Authentication Master (VAM) file of a registered user;
obtaining the Secure Transaction Code from the information received from the user device;
verifying that the Secure Transaction Code obtained from the information received from the user device is a valid Secure Transaction Code;
if it is verified that voice entry of the Secure Transaction Code corresponds to a Voice Authentication Master file of a registered user and if the Secure Transaction Code is verified as a valid Secure Transaction Code, authorizing the financial transaction; and
if the financial transaction is authorized, sending an indication that the financial transaction has been authorized to the user device.

2. The non-transitory computer readable medium of claim 1, further storing computer readable instructions, which when executed by at least one processor, implement further steps comprising:
receiving an identifier that is stored on the user device;
verifying that the identifier is an identifier associated with a registered user or an identifier of a registered user device; and
authorizing the financial transaction only if the identifier is verified as an identifier associated with a registered user or as an identifier associated with a registered user device.

3. The non-transitory computer readable medium of claim 2, wherein the identifier that is stored on the user device is a user device ID.

4. The non-transitory computer readable medium of claim 2, wherein the identifier that is stored on the user device is an International Mobile Station Equipment Identity (IMEI).

5. The non-transitory computer readable medium of claim 2, wherein the identifier that is stored on the user device is an Integrated Circuit Card Identifier (ICCID).

6. The non-transitory computer readable medium of claim 2, wherein the identifier that is stored on the user device is an International Mobile Subscriber Identity (IMSI).

7. The non-transitory computer readable medium of claim 2, wherein the identifier includes an application ID of a financial transaction application that is running on the user device and further comprising verifying that the application identifier is an identifier associated with a registered financial transaction application.

8. The non-transitory computer readable medium of claim 1, wherein the information regarding the financial transaction includes an initiator identifier, a transaction identifier, a date and time related to the transaction, and a transaction amount.

9. A computer system comprising at least one processor and the non-transitory computer readable medium and computer readable instructions of claim 1.

10. A non-transitory computer readable medium that stores computer readable instructions, which when executed by at least one processor, implement a method for implementing a financial transaction between a merchant and a user of a mobile user device, the method comprising:
receiving information regarding a financial transaction from a merchant;
generating a Secure Transaction Code from the received information, wherein the Secure Transaction Code is an alphanumeric value that binds the received information to the financial transaction;
receiving information from a mobile user device that includes a voice entry of the Secure Transaction Code;
verifying that the voice entry of the Secure Transaction Code corresponds to a Voice Authentication Master file of a registered user;
obtaining the Secure Transaction Code from the information received from the mobile user device;
verifying that the Secure Transaction Code obtained from the information received from the mobile user device is a valid Secure Transaction Code;
if it is verified that the voice entry of the Secure Transaction Code corresponds to a master file of a registered user and if the Secure Transaction Code is verified as a valid Secure Transaction Code, authorizing the financial transaction between the merchant and the registered user; and
if the financial transaction is authorized, sending an indication that the financial transaction has been authorized to the mobile user device.

11. A non-transitory computer readable medium that stores computer readable instructions, which when executed by at least one processor, implement a method for implementing a financial transaction between a merchant and a user of a mobile user device, the method comprising:
receiving information from a mobile user device that includes a voice entry of a Secure Transaction Code, wherein the Secure Transaction Code is an alphanumeric value that is generated from information regarding a financial transaction and that binds the received information to the financial transaction;
verifying that the voice entry of the Secure Transaction Code corresponds to a Voice Authentication Master file of a registered user;
obtaining the Secure Transaction Code from the information received from the mobile user device;
verifying that the Secure Transaction Code obtained from the information received from the user device is a valid Secure Transaction Code;
if it is verified that the voice entry of the Secure Transaction Code corresponds to a master file of a registered user and if the Secure Transaction Code is verified as a valid Secure Transaction Code, authorizing the financial transaction between the merchant and the registered user;
if the financial transaction is authorized, settling the financial transaction between the merchant and the registered user.

12. The non-transitory computer readable medium of claim 11, further storing computer readable instructions, which when executed by at least one processor, implement a further step comprising, if the financial transaction is authorized, sending an indication that the financial transaction has been authorized to the mobile user device.

13. The non-transitory computer readable medium of claim 11, further storing computer readable instructions, which when executed by at least one processor, implement further steps comprising:
receiving an identifier that is stored on the mobile user device;
verifying that the identifier is an identifier associated with a registered user or an identifier of a registered mobile user device; and
authorizing the financial transaction only if the identifier is verified as an identifier associated with a registered user or as an identifier associated with a registered mobile user device.

14. The non-transitory computer readable medium of claim 13, wherein the identifier that is stored on the mobile user device is a user device ID.

15. The non-transitory computer readable medium of claim 13, wherein the identifier that is stored on the mobile user device is an International Mobile Station Equipment Identity (IMEI).

16. The non-transitory computer readable medium of claim 13, wherein the identifier that is stored on the mobile user device is an Integrated Circuit Card Identifier (ICCID).

17. The non-transitory computer readable medium of claim 13, wherein the identifier that is stored on the mobile user device is an International Mobile Subscriber Identity (IMSI).

18. The non-transitory computer readable medium of claim 13, wherein the identifier includes an application ID of a financial transaction application that is running on the user device and further comprising verifying that the application identifier is an identifier associated with a registered financial transaction application.

19. A non-transitory computer readable medium that stores computer readable instructions, which when executed by at least one processor, implement a method for secure access via a user device, the method comprising:
receiving information regarding an access request;
generating a Secure Transaction Code from the received information, wherein the Secure Transaction Code is an alphanumeric value that binds the received information to the access request;
receiving information from a user device that includes a voice entry of the Secure Transaction Code;
verifying that the voice entry of the Secure Transaction Code corresponds to a Voice Authentication Master (VAM) file of a registered user;
obtaining the Secure Transaction Code from the information received from the user device;
verifying that the Secure Transaction Code obtained from the information received from the user device is a valid Secure Transaction Code;
if it is verified that the voice entry of the Secure Transaction Code corresponds to a Voice Authentication Master file of a registered user and if the Secure Transaction Code is verified as a valid Secure Transaction Code, authorizing the access request; and
if the access request is authorized, sending an indication that the access request has been authorized to the user device.

20. A non-transitory computer readable medium that stores computer readable instructions, which when executed by at least one processor, implement a method for implementing a secure transaction via a user device, the method comprising:
receiving information regarding a secure transaction;
generating a Secure Transaction Code from the received information, wherein the Secure Transaction Code is an alphanumeric value that binds the received information to the secure transaction;
receiving verification information and the Secure Transaction Code from a user device;
verifying that the verification information corresponds to verification information of a registered user;
verifying that the Secure Transaction Code obtained from the user device is a valid Secure Transaction Code;
if it is verified that the verification information corresponds to verification information of a registered user and if the Secure Transaction Code is verified as a valid Secure Transaction Code, authorizing the secure transaction; and
if the financial transaction is authorized, sending an indication that the secure transaction has been authorized to the user device.
